(19) United States
(12) Patent Application Publication
(10) Pub. No.: US 2020/0349468 A1
(43) Pub. Date: Nov. 5, 2020

(54) DATA MANAGEMENT PLATFORM FOR MACHINE LEARNING MODELS

(71) Applicant: Apple Inc., Cupertino, CA (US)

(72) Inventors: Rajat ARYA, Kirkland, WA (US); Pulkit AGRAWAL, Seattle, WA (US); Kaiyu ZHAO, Redmond, WA (US); Yucheng LOW, Seattle, WA (US); Joseph E. GODLEWSKI, Seattle, WA (US); Mudit Manu PALIWAL, Seattle, WA (US); Vishrut SHAH, Redmond, WA (US); Bochao SHEN, Sammamish, WA (US); Anupriya GAGNEJA, Bellevue, WA (US); Laura SUGDEN, Redmond, WA (US); Balan RAMAN, Redmond, WA (US); Ming-Chuan WU, Bellevue, WA (US); Sandeep BHATIA, Bothell, WA (US); Aanchal BINDAL, Seattle, WA (US)

(21) Appl. No.: 16/583,137

(22) Filed: Sep. 25, 2019

Related U.S. Application Data
(60) Provisional application No. 62/843,286, filed on May 3, 2019.

(51) Int. Cl. G06N 20/00; G06K 9/62; G06F 16/953

(52) U.S. Cl. CPC G06N 20/00; G06F 16/953; G06K 9/6256

(57) ABSTRACT

The subject technology generates a dataset based at least in part on a set of files. The subject technology generates, utilizing a machine learning model, a set of labels corresponding to the dataset. The subject technology filters the dataset using a set of conditions to generate at least a subset of the dataset. The subject technology generates a virtual object based at least in part on the subset of the dataset and the set of labels, where the virtual object corresponds to a selection of data from the dataset. The subject technology trains a second machine learning model using the virtual object and at least the subset of the dataset, where training the second machine learning model includes utilizing streaming file input/output (I/O), the streaming file I/O providing access to at least the subset of the dataset during training.

### CROSS-REFERENCE TO RELATED APPLICATIONS

The present application claims the benefit of U,S, Provisional Patent Application Ser. No. 62/843,286, entitled “DATA MANAGEMENT PLATFORM FOR MACHINE LEARNING MODELS,” filed May 3, 2019, which is hereby incorporated herein by reference in its entirety and made part of the present U.S. Utility Patent Application for all purposes.

### TECHNICAL FIELD

The present description generally relates to developing machine earning applications.

### BACKGROUND

Software engineers and scientists have been using computer hardware for machine learning to make improvements across different industry applications including image classification, video analytics, speech recognition and natural language processing, etc.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for in accordance with one or more implementations,

FIG. 2 illustrates an example computing architecture for a system providing data management of machine learning models, in accordance with one or more implementations.

FIG. 3 conceptually illustrates an example dataset object in accordance with one or more implementations.

FIG. 4 conceptually illustrates an example annotation object associated with the dataset object in accordance with one or more implementations.

FIG. 5 conceptually illustrates an example split object and another split object associated with the dataset object in accordance with one or more implementations.

FIG. 6 illustrates an example file hierarchy that portions of the computing environment described in FIG. 2. are able to access (e.g., by using one or more APIs) in accordance with one or more implementations.

FIG. 7 illustrates an example of a code listing for creating a dataset object and a code listing for creating a new version of an annotation object on the dataset object in accordance with one or more implementations.

FIG. 8 illustrates an example of a code listing for creating a split and a code listing for creating a package in accordance with one or more implementations.

FIG. 9 illustrates an example code listing for training an activity classifier in accordance with one or more implementations.

FIG. 10 illustrates an example code listing for mounting a given dataset in accordance with one or more implementations.

FIG. 11 illustrates an example code listing for using a table API with secondary indexes to access data in accordance with one or more implementations.

FIG. 12 illustrates an example of a physical data layout in accordance with one or more implementations of the subject technology.

FIG. 13 illustrates an example of creating a new version of a dataset using a copy-on-write operation in accordance with one or more implementations of the subject technology.

FIG. 14 illustrates an example of using a secondary index to map keys into data block identifiers (IDs) and to retrieve data of interest in accordance with one or more implementations of the subject technology.

FIG. 15 illustrates a flow diagram of an example process for creating a dataset and other objects for training a machine learning model in accordance with one or more implementations.

FIG. 16 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Machine learning has seen a significant rise in popularity in recent years due to the availability of massive amounts of training data, and advances in more powerful and efficient computing hardware. Machine learning may utilize models that are executed to provide predictions in particular applications (e.g., analyzing images and videos) among many other types of applications.

A machine learning lifecycle may include the following distinct stages: data collection, annotation, exploration, feature engineering, experimentation, evaluation, and deployment. The machine learning lifecycle is iterative from data collection through evaluation. At each stage, any prior stage could be revisited, and each stage can also change the size and. shape of the data used to generate the ML model. During data collection, raw data is curated and cleansed, annotated, and then partitioned. Even after a model is deployed, new data may be collected while some of the existing data may be discarded.

In some instances, there has been little emphasis on implementing a data management system to support machine learning in a holistic manner. The emphasis, instead, has been on isolated phases of the lifecycle, such as model training, experimentation, and evaluation, and deployment. Such systems have relied on existing data management systems, such as cloud storage services, on-premises distributed file system, or other database solutions.

Machine learning (ML) workloads therefore may benefit from new and/or additional features for the storage and management of data. In an example, these features may fall under one or more of the following categories: 1) supporting the engineering teams, 2) supporting the machine learning lifecycle, and/or 3) supporting the variety of ML frameworks and ML data.

In some service models, data is encapsulated behind a service interface and any change in data is not known to the consumers of the service. In machine learning, data itself is an interface which may need to be tracked and versioned. Hence, the ability to identify the ownership, the lineage, and the provenance of data may be beneficial for such a system. Since data evolves through the life of the project, engineering teams may utilize data lifecycle management features to understand how the data has changed.

A machine learning lifecycle may be highly-iterative and experimental. For example, after hundreds or thousands of experiments, a promising mix of data, ML features, and a trained ML model can emerge. It can be typical for a team of users (e.g., engineers) to be conducting experiments across a variety of partitions of data. In any highly experimental process, it can be beneficial that the results are reproducible as needed. Existing data systems may not be well designed for ad-hoc or experimental workloads, and can lack the support to reproduce such results, e.g., the capability to track the dependencies among versioned data, queries, and results. Further, it may be beneficial for pipelines that are ingesting data to keep track of their origins. It is also important to keep track of the lineage of derived data, such as labels and annotations. In case of errors found in the source dataset, all the dependent and derived data may be identified, and owners may be notified to regenerate the labels or annotations.

Implementations of the subject technology improve the computing functionality of a given electronic device by 1) providing an abstraction of raw data as files thereby improving the efficiency of accessing and loading the raw data for ML applications, 2) providing a declarative programming language that eases the tasks of data and feature engineering for ML applications, and 3) providing a data model that enables separation of data, via respective objects, from a given dataset to facilitate ML development while avoiding duplication of raw data included in the dataset such that different ML models can utilize the same set of raw data while generating different subsets of the raw data and/or different annotations of such raw data that are more tailored to a respective ML model. These benefits therefore are understood as improving the computing functionality of a given electronic device, such as an end user device which may generally have less computational and/or power resources available than, e.g., one or more cloud-based servers.

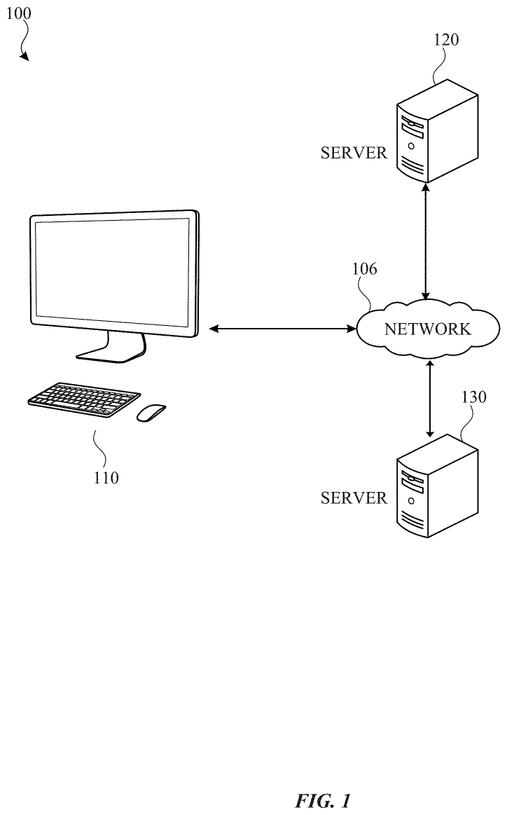

FIG. 1 illustrates an example network environment 100 for in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, a server 120, and a server 130. The network 106 may communicatively (directly or indirectly) couple the electronic device 110 and/or the server 120 and/or the server 130. in one or more implementations, the network 106 may be an interconnected network of devices that may include, or may be communicatively coupled to, the Internet. For explanatory purposes, the network environment 100 is illustrated in FIG. 1 as including the electronic device 110, the server 120, and the server 130; however, the network environment 100 may include any number of electronic devices and any number of servers.

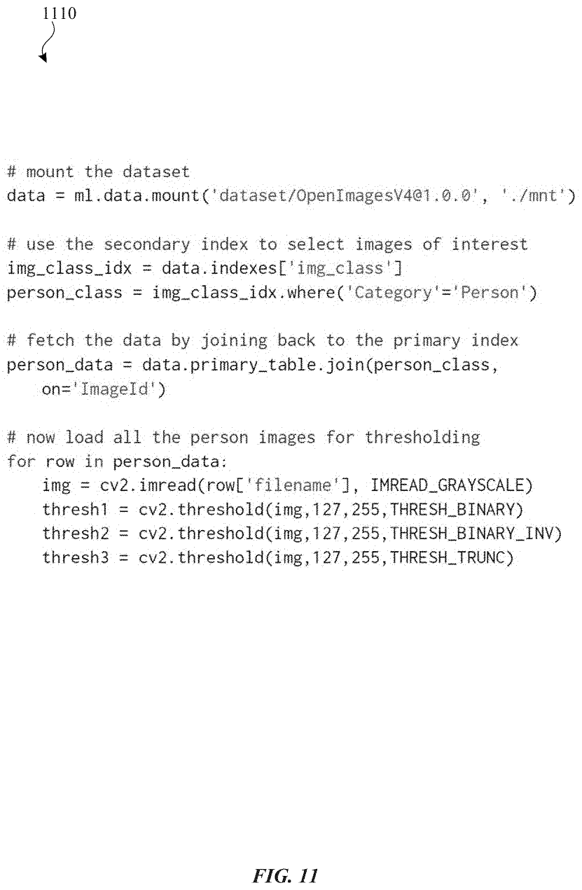

The electronic device 110 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a desktop computer. The electronic device 110 may be, and/or may include all or part of, the electronic system discussed below with respect to FIG. 11.

In one or more implementations, the electronic device 110 may provide a system for compiling machine learning models into executable form (e.g., compiled code). In particular, the subject system may include a compiler for compiling source code associated with machine learning models. The electronic device 110 may provide one or more machine learning frameworks for developing applications using machine learning models. In an example, machine learning frameworks can provide various machine learning algorithms and models for different problem domains in machine learning. Each framework may have strengths for different models, and several frameworks may be utilized within a given project (including different versions of the same framework). Such frameworks can rely on the file system to access training data, with some frameworks offering additional data reader interfaces to make I/O more efficient. Given the numerous frameworks, the subject system as described herein facilitates interoperability, using a file system based integration, with the different frameworks in a way that appears transparent to a user/developer. Moreover, the subject system integrates with execution environments used for experimentation and model evaluation.

The server 120 may provide a machine learning (ML) data management service (discussed further below) that supports the full lifecycle management of the ML data, sharing of ML datasets, independent version evolution, and efficient data loading for ML experimentation. The electronic device 110, for example, may communicate with the ML data management service provided by the server 120 to facilitate the development of machine learning models for machine learning applications, including at least generating datasets and/or training machine learning models using such datasets.

In one or more implementations, the server 130 may provide a data system for enabling access to raw data associated with machine learning models and/or cloud storage for storing raw data associated with machine learning models. The electronic device 110, for example, may communicate with such a data system provided by the server 130 to access raw data for machine learning models and/or to facilitate generating datasets based on such raw data for use in machine learning models as described further herein.

In one or more implementations, as discussed further below, the subject system provides REST APIs and client SDKs for client-side data access, and a domain specific language (DSL) for server-side data processing. In an example, the server-side service includes control plane and data plane APIs to assist data management and data consumption, which is discussed below.

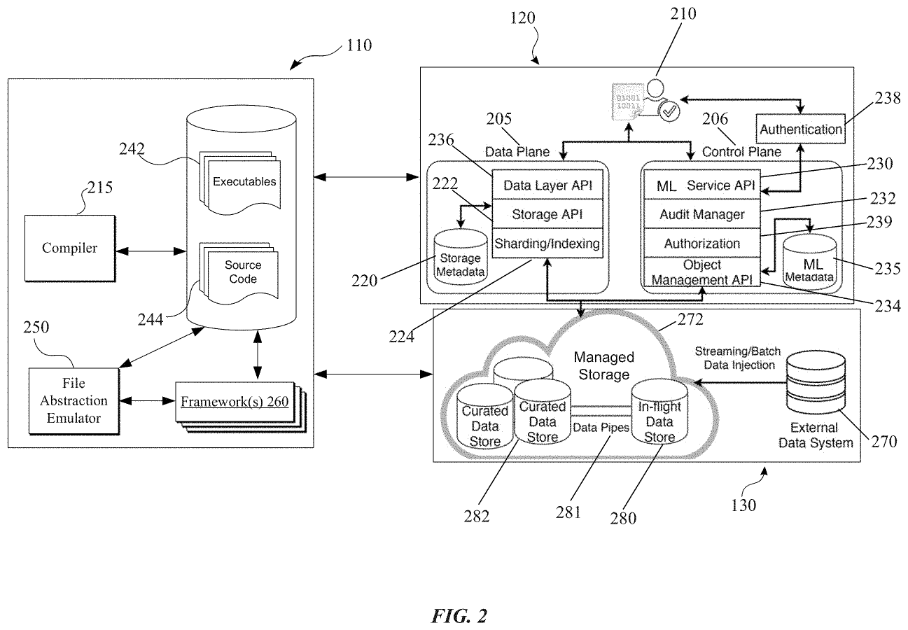

The following discussion of FIG. 2 shows components of the subject system, which enable at least the following: 1) a conceptual data model to naturally describe raw data assets versus features annotations derived from the raw data; 2) a version control scheme to ensure reproducibility of ML experiments on immutable snapshot of datasets; 3) data access interfaces that can be seamlessly integrated with ML frameworks as well as other data processing systems; 4) a hybrid data store design that is well-suited for both continuous data injection with high concurrent updates and slowly-changing curated data; 5) a storage layout design that enables delta tracking between different versions, data parallelism for distributed training, indexing for efficient search and data exploration, and streaming 110 to support both training on devices or in the data center; and 6) a distributed cache to accelerate ML training tasks.

FIG. 2 illustrates an example computing architecture for a system providing data management of machine learning models, in accordance with one or more implementations. For explanatory purposes, the computing architecture is described as being provided by the electronic device 110, the server 120, and the server 130 of FIG. 1, such as by a processor and/or memory of the electronic device 110 and/or the server 120 and/or the server 130; however, the computing architecture may be implemented by any other electronic devices. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 110 includes a compiler 215. Source code 244, which after being compiled by the compiler 215, generates executables 242 that can be executed either locally or sent remotely for execution (e.g., by an elastic compute service that provides dynamically adaptable computing capacity in the cloud). In an example, the source code 244 may include code for various algorithms, which may be utilized, alone or in combination, to implement particular functionality associated with machine learning models for executing on a given target device. As further described herein, such source code may include statements corresponding to a high-level domain specific language (DSL) for data definition and feature engineering. In an example, the provides an implementation of a declarative programming paradigm that enables declarative statements to be included in the source code to pull and/or process data. More specifically, user programs can include code statements that describe the intent (e.g., type of request), which will be compiled into execution graphs, and can be either executed locally and/or submitted to an elastic compute service for execution. The DSL enables the subject system to record the intent in metadata, which will enable query optimization based on the matching of query and data definitions, similar to view matching and index selection in a given database system.

The electronic device 110 includes a framework(s) 260 that provides various machine learning algorithms and models. A framework can refer to a software environment that provides particular functionality as part of a larger software platform to facilitate development of software applications that utilize machine learning models, and may provide one or more application programming interfaces (APIs) that may be utilized by developers to design, in a programmatic manner, such applications that utilize machine learning models. In an example, a compiled executable can utilize one or more APIs provided by the framework 260.

The electronic device 110 includes a file abstraction emulator 250 that provides an emulation of a file system to enable an abstraction of raw data, either stored locally at the electronic device 110 and/or the server 130, as one or more files. In an implementation, the file abstraction emulator 250 may work in conjunction with the framework 260 and/or a compiled executable to enable access to the raw data. In an example, the file abstraction emulator 250 provides a file I/O interface to access raw data using file system concepts (e.g., reading and/or writing files, etc.) that enables ML applications to have a unified data access experience to raw data irrespective of OS platforms, runtime environments, and/or ML frameworks.

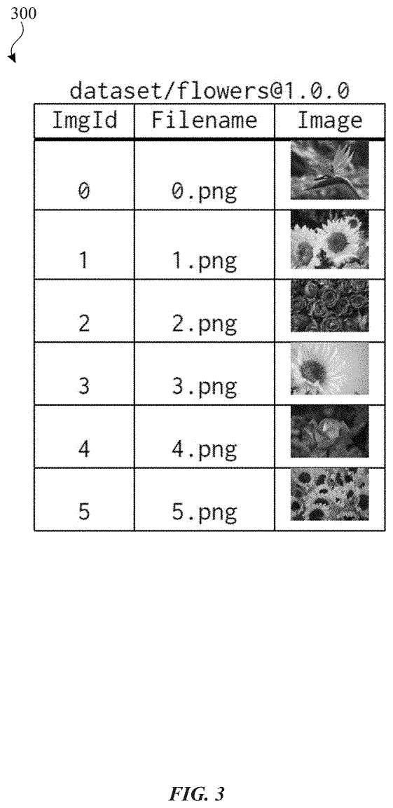

As shown, the server 120 provides various components separated into a data plane 205 and a control plane 206, which is described in the following discussion. For instance, in the control plane 206, the server 120 includes a ML metadata store 235 which may include a relational database that includes information corresponding to the relationships between the objects and users. Examples of objects are discussed further below in the examples of FIGS. 3-5. In an implementation, the ML metadata store 235 includes information corresponding to permissions, version information, and user information. Examples of such user information include which user created a respective object, which user last edited the object, auditing information, and which users have accessed the object. Although the ML metadata store 235 is shown as being included in the server 120, in other implementations, such a storage metadata may be included in the server 130 or another electronic device that the electronic device 110 can access. As included in the data plane 205, a data layer API 236 is responsible for determining where the data is (e.g., the particular location(s) of such data), and where data should be stored. In an implementation, the data layer API 236 can include a user facing set of APIs that users interact with (e.g., by making API calls) for accessing data stored in the subject system. The data plane 205 further includes a storage API 222 that provides functionality for reading and writing data into storage (e.g., a storage device or storage location), including representing the data in an appropriate physical format for storage at a corresponding physical location. As discussed further herein, data in the subject system may be represented as a collection of blocks that are mapped to various physical locations of storage. In an example, the storage API 222 uses a storage metadata 220 to track which blocks correspond to which particular dataset.

As further shown in the data plane 205, a sharding and indexing component 224 is responsible for determining how blocks are divided and stored in respective locations across one or more storage locations or devices. In an example, the storage API 222 sends a request to the sharding and indexing component 224 for storing a particular dataset (e.g., a collection of files). In response to the request, the sharding and indexing component 224 can split the data into shards, write the dataset into blocks corresponding to the shards, and index the written dataset in a correct manner. Further, the sharding and indexing component 224 provides metadata information to the storage API 222, which is stored in the storage metadata 220.

As shown in the control plane 206, a machine learning if) data management service 230 provides, in an implementation, a set of REST (representational state transfer) APIs for handling requests related to machine learning applications. In an example, the ML data management service 230 provides APIs for a control plane or a data plane to enable data management and data consumption. An audit manager 232 provides compliance and auditing for data access as described further below. An authentication component 238 and/or an authorization component 239 may work in conjunction with the audit manager 232 to help determine compliance with privacy or security policies and whether access to particular data should be permitted. The authentication component 238 may perform authentication of users 210 (e.g., based on user credentials, etc.) that request access to data stored in the system. If authentication of a particular user fails, then the authentication component 238 can deny access to the user. For users that are authenticated, different levels of access (e.g., viewer, consumer, owner, etc.) may be attributed to users that are requesting access to data, and the authorization component 239 can determine whether such users are permitted access to such data based on their level of access. An object management API 234 handles mapping of objects consistent with a data model as described further herein, and can communicate with the audit manager 232 to determine whether access should be granted to objects and/or datasets.

In one or more implementations, privacy preserving policies may be supported by components of the system. The audit manager 232 may audit activity that is occurring in the system including each occurrence when there is a change in the system (e.g., to a particular object and/or data). Further, the audit manager 232 helps ensure that data is being used appropriately. For example, in an implementation, each object and dataset has a terms of use which includes definitions or parameters to which the object or dataset may be utilized. In one or more implementations, the terms of use can be written in very simple language such that each user can determine how to use the object or dataset. An example terms of use can include whether a particular machine learning model can be used for shipping with a particular electronic device (e.g., for a device that goes into production). Moreover, audit manager 232 can also identify whether the object or dataset includes personal identifiable information (PII), and if so, can further identify if there are any additional restrictions and/or how PII can be utilized. In one or more implementations, at an initial time that the object or dataset is requested, an agreement to the terms of use may be provided. Upon agreement with the terms of use, access to the object or dataset may then be granted.

Further, the subject system supports including an expiration time for data associated with the object or dataset. For example, there might be a time period on which certain data can be utilized (e.g., six months or some other time period). After such a time period, the data should be discarded. in this regard, each object in the system may include an expiration time. The audit manager 232 can determine whether a particular expiration time for the object or dataset is still valid and grant or deny access to the object or dataset. In an example where the object or dataset has expired, the audit manager 232 may return an error message indicating that the object or dataset has expired. Further, the audit manager 232 may log each instance where an error messaged is generated upon an attempted access of an expired object or dataset.

As further illustrated, the server 130 may include an external data system 270 and a managed storage 272 for storing raw data for machine learning models. The data layer API 236 may communication with the external data system 270 in order to access raw data stored in the managed storage 272. As further shown, the managed storage 272 includes one or more curated data stores 282 and an in-flight data store 280, which are communicatively coupled via data pipes 281. The curated data stores 282 stores curated data (which is discussed further below) that, in an example, corresponds to data that does not change frequently. In comparison, the in-flight data store 280 can be utilized by the subject system to store data that is not yet curated and can undergo further processing and refinement as part of the ML development lifecycle. For example, when a new machine learning model undergoes development or a machine learning feature is introduced into an existing ML model, data that is utilized can be stored in the in-flight data store 280. When such in-flight data reaches an appropriate point of maturation (e.g., where further changes to the data is not needed in a frequent manner), the corresponding in-flight data can be transferred to the curated data stores 282 for storage.

As mentioned above, the subject system implements a data model that is aimed at supporting 1) the full lifecycle management of the ML data, 2) sharing of ML datasets, 3) independent version evolution, and 4) efficient data loading for ML experimentation. In this regard, the subject system implements a data model that includes four high-level concepts corresponding to different objects: 1) dataset, 2) annotation, split, and 4) package.

A dataset object is a collection of entities that are the main subjects of ML trainings. An annotation object is a collection of labels (and-'or features) describing the entities in its associated dataset. Annotations, for example, identify which data makes up the features in the dataset, which can differ from model to model using the same dataset. A split object is a collection of data subsets from its associated dataset. In an example, a dataset object may be split into a training set, a testing set, and/or a validation set. In one or more implementations, both annotations and splits are weak objects, and do not exist by themselves. Instead, annotations and splits are associated with a particular dataset object. A dataset object can have multiple annotations and splits. A package object is a virtual object, and provides a conceptual view over datasets, annotations, and/or splits. Similar to the concept of a view (e.g., a result set of a stored query on the data, which can be queried for) in a database, packages offer a higher-level abstraction to hide the physical definitions of individual objects.

It is appreciated that the subject system enables different sets of annotations objects, corresponding to different machine learning models, to share the same dataset so that such a dataset is not duplicated for each annotation. Each dataset therefore can be associated with multiple annotation objects e.g., one for each ML model using the data set, such that the same underlying data can be stored once and concurrently reused in different models with different labels). Moreover, different package objects with different annotation objects can also utilize the same dataset. For example, a first machine learning application can generate a first annotation object with a first set of labels for a particular dataset, while a second machine learning application can generate a second annotation object with a different set of labels for the same dataset as used by the first machine learning application. These respective machine learning applications can then generate different split objects and/or package objects that are applicable for training their respective machine learning models.

To further illustrate, the following discussion relates to examples of objects utilized by the subject system for supporting data management for developing machine learning models throughout the various stages of the ML lifecycle (e.g., model training, experimentation, and evaluation, and deployment).

FIG. 3 conceptually illustrates an example dataset object in accordance with one or more implementations. FIG. 3 will be discussed by reference to FIG. 2, particularly with respect to respective components of the server 120 and/or the server 130.

In the example of FIG. 3, a representation of a dataset object 300 is shown that includes of a collection of image files. In an example, a user may utilize the object management API 234 and the data layer API 236 to generate the dataset object 300. The dataset object 300 is represented in a tabular format as a table with a separate row for each file. As shown, each row includes a column for an image identifier, a filename, and a thumbnail representation of an image corresponding to the filename.

In an implementation, the only schema requirement is the primary key of a dataset, which uniquely identifies an entity in a dataset. In addition, it defines the foreign key in both annotations and splits to reference the associated entities in the datasets. Further, columns in a given table can be of scalar types, as well as collection types. Scalar types include number, string, date-time, and byte stream, while collection types include vector, set, and dictionary (document). Tables can be stored in the column-wise fashion. In an example, such a columnar layout yields a high compression rate which in turn reduces the I/O bandwidth requirements, and it also allows adding and removing columns efficiently. In addition, such tables are scalable data structures, without the restriction of a main memory size.

Datasets for machine learning often contain a list of raw files. For example, to build a human posture and movement classification model, one entity in the dataset may consist of a set of video files of the same subject/movement from different angles, plus a JSON (JavaScript Object Notation) file containing the accelerometer signals. In an implementation, the subject system stores files as byte streams in the table. The subject system, in an implementation, provides streaming file accesses to those files, as well as custom connectors to popular formats for storing data (e.g., TFRecord in TensorFlow, and RecordIO in MXNet). Moreover, in an implementation, the subject system allows user-defined access paths, such as primary indexes, secondary indexes, partial indexes (or, filtered index), etc.

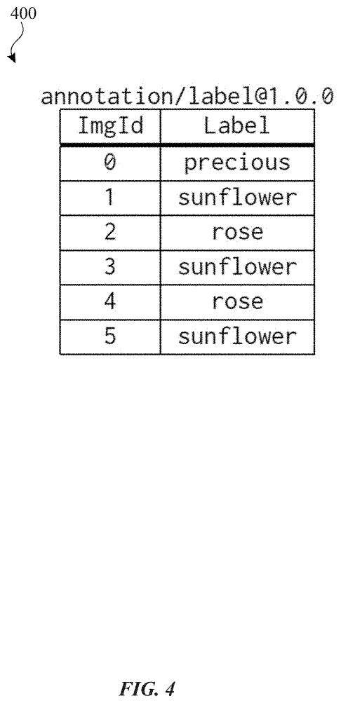

FIG. 4 conceptually illustrates an example annotation object associated with the dataset object 300 in accordance with one or more implementations. FIG. 4 will be discussed by reference to FIG. 3, particularly with the dataset object 300.

As illustrated in FIG. 4, a representation of an annotation object 400 includes a respective row for each label. As shown, each row includes a column for an image identifier, and a label corresponding to the image identifier. The information provided by the annotation object 400 is derived from the dataset object 300. The annotation object 400 includes respective labels that correspond to extracted features, or supplementary properties of the associated dataset object(s) (e.g., the dataset object 300).

The advantages of separating (or, normalizing) annotations and/or splits from corresponding datasets are numerous, including enabling different ML applications to label or split the data in a different manner. For example, to train an object recognition model a user may want to label the bounding boxes in the images, and while training a scene classification model a user may want to label the borders of each objects in the images. Normalization also enables the same ML application to evolve the labels or to employ different splits for different experiments. For example, a failed experiment may prompt a new labeling effort creating a new annotation. To experiment with different learning strategies, a user may want to mix and partition the dataset in different ways. In this manner, the same dataset can be reused while different annotations objects and split objects are utilized for a different machine learning models and/or applications.

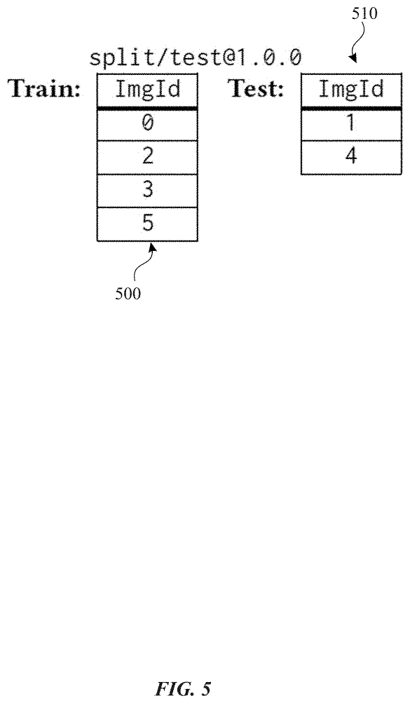

FIG. 5 conceptually illustrates an example split object 500 and split object 510 associated with the dataset object 300 in accordance with one or more implementations. FIG. 5 will be discussed by reference to FIG. 3, particularly with the dataset object 300.

As illustrated in FIG. 5, a representation of the split object 500 includes a respective row for each image identifier. Similarly, a representation of the split object 510 includes a respective row for each image identifier. The information provided by the split object 500 and the split object 510 is derived from the dataset object 300. In this example, the split object 500 corresponds to a set of data for training a particular machine learning model, and the split object 510 corresponds to a set of data for testing for the machine learning model.

Split objects are similar to partial indexes in databases. By separating data into annotation and/or split objects, both can evolve without changing the corresponding dataset object. In practice, dataset acquisition and curation can be costly, labor intensive, and time consuming. Once a dataset is curated, such a dataset serves as the ground truth (e.g., proper objective and provable data) and will often be shared among different projects/teams. Thus, it can be desirable that the ground truth does not change, and to enable each project/team to label and organize the data based on its own needs and cadence.

Normalization (e.g., separating annotations and/or splits from corresponding datasets) may also be utilized to ensure compliance with legal or compliance requirements. In some situations, labeling or feature engineering may involve additional data collection which is done under different contractual agreements than the base dataset. The subject system enables independent permissions and “Terms of Use” settings for datasets, annotations and packages.

In machine learning, data may be considered an interface. Thus, any changes (either insertion, deletion or updates) in data may be versioned just like software is versioned due to code changes. The subject system therefore provides a strong versioning scheme on all four high-level objects, In an implementation, version evolutions are categorized into schema, revision, and patch, resulting in a three-part version number corresponding to the following format:

<schema>.<revision>.<patch>

A schema version change signals that the schema of the data has changed, so code changes may be required to consume the new version of the data. Both revision and patch version changes denote that the data is updated, deleted, and/or new entities have been added without schema changes. Existing applications should continue to work on new revisions or patches. If the scope of changes impacts the results of the model training, e.g., the data distribution has significant changes that can impact the reproducibility of the training results, then the data should be marked as a revision, otherwise the data is marked as a patch. One scenario of a patch is when a tiny fraction of the data is malformed during injection, and re-touching those data results in a new patched version. In one or more implementations, it may be beneficial for applications bind to the specific version to ensure reproducibility.

In contrast to other multi-versioned data systems where the versioning is implicit and system-driven, the versioning provided by implementations described herein is explicit and application-driven. Consequently, version management as described herein allows different ML projects to: 1) share and to evolve the versions on their own cadence and needs without disrupting other projects, 2) pin a specific version in order to reproduce the training results, and 3) track version dependencies between data and trained models.

To assist the lifecycle management, each version of the aforementioned objects can be in one of the four states: 1) draft, 2) published, 3) archived, and 4) purged. The “draft” state offers applications the opportunity to validate the soundness of the data before transitioning it into the “published” state. In an implementation, a mechanism to update a published data is to create a new version of it. Once the data is expired or no longer needed, it can be transitioned into the “archived” state, or into the “purged” state to be completely removed from the persisted storage. For example, when a user opts out the user study, all the data collected on that user will be deleted resulting in a new patched version, while all the previous versions will be purged.

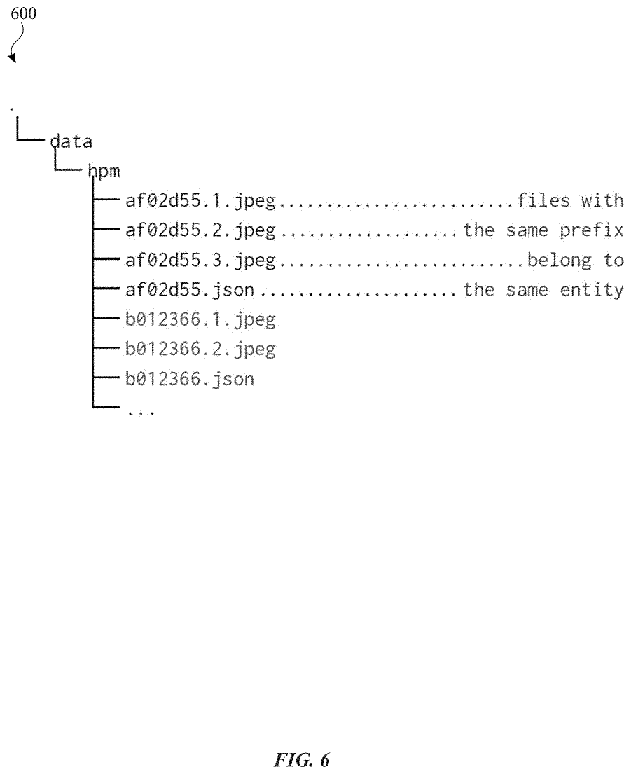

As mentioned above, the subject system provides a high-level domain specific language (DSL) for data definition and feature engineering in machine learning workflows. The following description in FIGS. 6-9 relates to example uses of the DSL for 1) creating a dataset from a set of raw images and JSON files, 2) using a user supplied ML model to create labels and publish them as a new version of an annotation, creating a split with filter conditions, and a package, and 4) training an activity classifier model.

FIG. 6 illustrates an example file hierarchy 600 that portions of the computing environment described in FIG. 2 are able to access (e.g., by using one or more APIs) in accordance with one or more implementations.

In the example of FIG. 6, raw files in located in a file directory structure with a path corresponding to ./data/hpm. Such raw files, in this example, are utilized for creating a dataset. The files under ./data/hpm are organized with the path prefix to each file as a unique identifier to a logical entity in a dataset, which contains a set of JPEG files, and the accelerometer readings in one JSON file. Thus, files with the same path prefix belong to the same entity in the dataset.

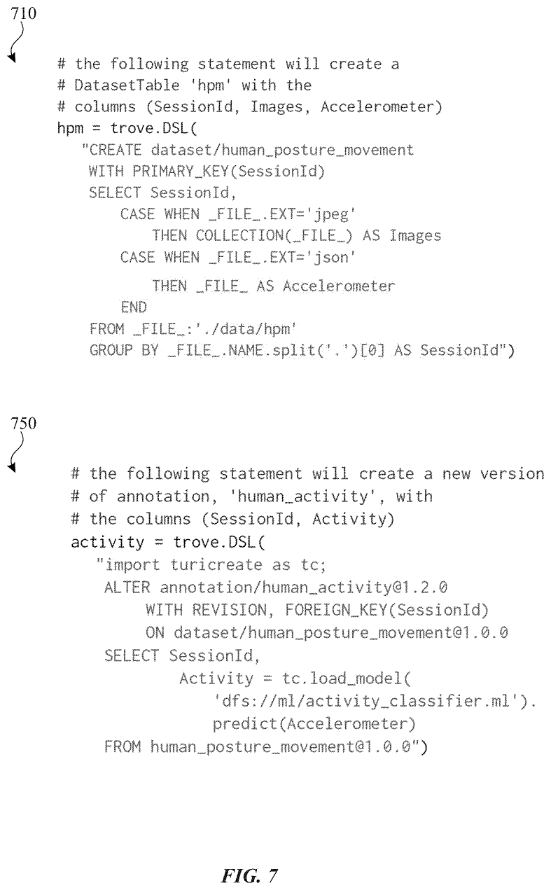

FIG. 7 illustrates an example of a code listing 710 for creating a dataset object and a code listing 750 for creating a new version of an annotation object on the dataset object in accordance with one or more implementations.

In the code listing 710, the “CREATE dataset . . . WITH PRIMARY_KEY” clause defines the metadata of the dataset, while the SELECT clause describes the input data. The syntax <qualifier>/<name>@<version>denotes the uniform resource identifier (URI) for Trove objects. In this example, the URI is dataset/human_posture_movement without the version, since CREATE statement may create version 1.0.0. The FROM sub-clause declares the variable binding, to each file in the given directory. The files are grouped by the path prefix, _FILE_NAME.split(‘.’)[0], which is declared as the primary key of the dataset. Within each group of files, all the JPEG files are put into the Images collection column, and the JSON file is put into the Accelerometer column,

As further shown in FIG. 7, the function, trove.DSL(), will compile and execute the statement, and the results will be assigned to the variable hpm, a scalable distributed data table. The statement can be executed in the one-box mode, or in a distributed environment. In this example, hpm is a local variable in the script. Any further manipulation on hpm will not be automatically reflected onto the dataset human_posture_movement, unless hpm.save() is called.

As shown in the code listing 750, the code creates a new version of annotation on the human_posture_movement dataset. The reserved symbol, is used to specific a particular version of the object. The clause “ALTER . . . WITH REVISION” creates a revision version off of the specified version. In this example, the new version will be human_activity@1.3.0. The ON sub-clause specifies the version of the dataset which this annotation refers to. The SELECT clause defines the input data, where the FROM sub-clause specifies data source. As mentioned above, in one or more implementations, primary keys and foreign keys may be the only schema requirements of any of the objects. A Sessionld, which is declared as the foreign key, may be defined in the SELECT list. This example also demonstrates user code integration with the DSL. Further, user code dependencies are to be declared by the import statements.

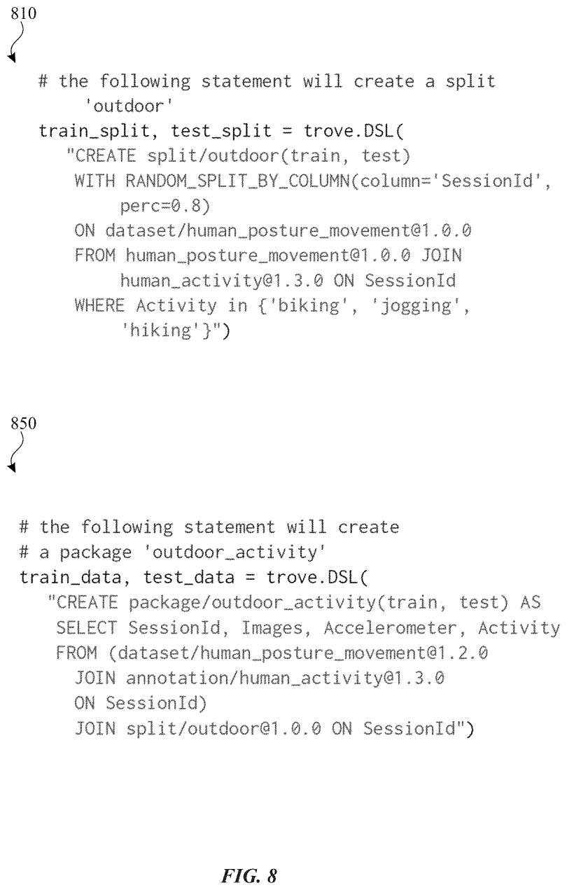

FIG. 8 illustrates an example of a code listing 810 for creating a split and a code listing 850 for creating a package (e.g., virtual object) in accordance with one or more implementations.

As shown, the code in the code listing 810 creates the split, outdoor, which contains two subsets: a training set (train) and a testing set (test). Similar to previous examples, the ON clause defines the dataset which this split refers to, and the FROM clause specifies the data source, which is the join between human_activity@1.3.0 and human_posture_movement@1.0.0. The optional WHERE clause specifies the filter conditions. The split labelled as “outdoor” only contains entities labelled as one of the three outdoor activities. In an example, a split does not contain any user defined columns. Instead, the split only contains the reference key (foreign key) to the corresponding dataset. As a result, the SELECT clause may not be supported in the CREATE split or ALTER split statements. Finally, the parameter, perc=0.8, in the RANDOM_SPLIT_BY_COLUMN function specifies that 80% of entities will be included in the training set, and the rest will be included in the testing set.

The code in the code listing 850 creates the package, outdoor_activity, which is defined as a virtual view over a three-way join among human_posture_movement, human_activity, and outdoor on the primary key and foreign keys. The SELECT list defines columns of the view.

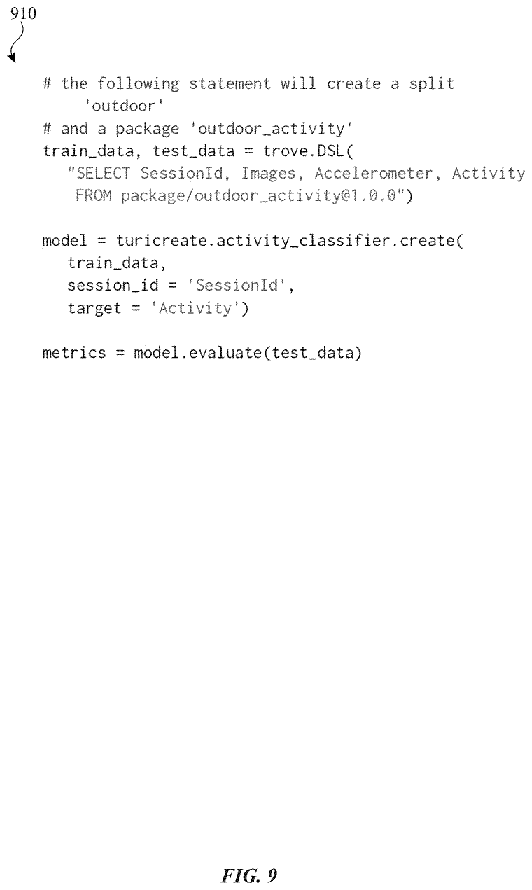

FIG. 9 illustrates an example code listing 910 for raining an activity classifier in accordance with one or more implementations.

As shown in the code listing 910, a simple model training example is included. The code first loads the package, outdoor_activity, into both train_data and test_data tables. Next, the code creates and trains the model using the training data. Finally, the code evaluates the model performance using the testing data.

From the above examples, it can be appreciated that the DSL leverages SQL expressiveness to simplify the tasks of data and feature engineering.

The following discussion relates to low-level data primitives. The subject system enables data access primitives that provide direct access to data via streaming file I/Os and a table API. In an example, the streaming on-demand enables effective data parallelism in distributed training of machine learning models.

The following discussion discusses streaming file I/O in more details. ML datasets may contain collections of raw multimedia files that the ML models directly work on. The subject system, in an implementation, provides a client SDK enables applications to mount objects through a mount command that provides a mount point, and the mount point exposes those raw files in a logical file system. The mount point therefore facilitates a file system view, which enables access to raw files across one or more machine learning frameworks and/or one or more storage locations. Moreover, it is appreciated that by providing such a file system view, an arbitrary amount of data can be accessed by the subject system (e.g., during training of a machine learning model).

In an example, the aforementioned mount command facilitates data streaming on-demand. Using streaming, physical blocks containing the files or the portion of a table being accessed are transmitted to the client machine in time. In an example, streaming of such raw files advantageously reduces GPU idle time thereby potentially increasing the computation efficiency of the subject system. In an implementation, rudimentary prefetching and local caching are implemented in the mount-client. Many of the Mt frameworks support file I/Os in their data access abstraction, and the mounted logical file system therefore provides a basic integration with most of the MI. frameworks. To support ML applications running on the edge, the subject system also provides direct file access via a REST API in an implementation.

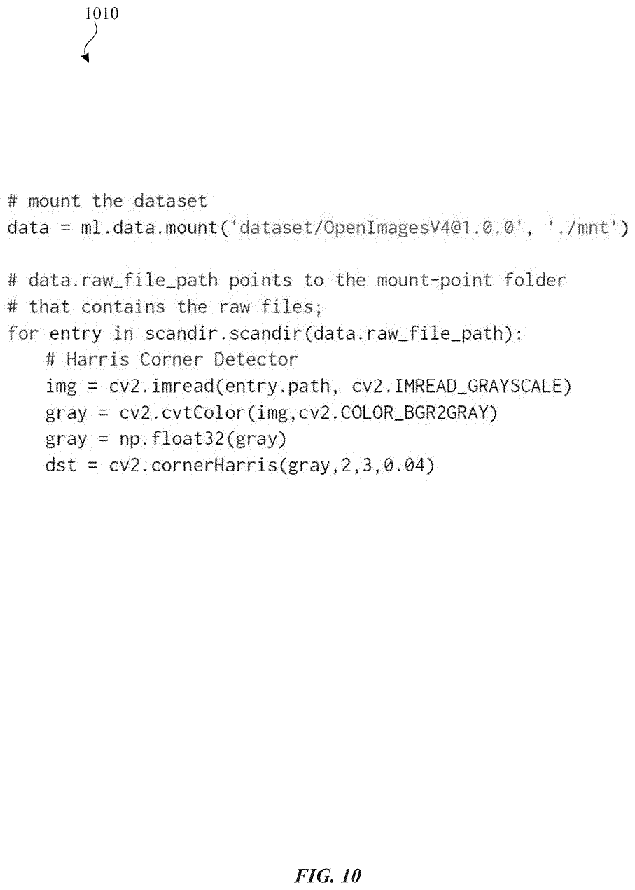

FIG. 10 illustrates an example code listing 1010 for mounting a given dataset in accordance with one or more implementations.

As shown in the code listing 1010, a Python application mounts the OpenImages dataset, and performs corner detection on each image by directly reading the image files.

FIG. 11 illustrates an example code listing 1110 for using a table API with secondary indexes to access data in accordance with one or more implementations.

As discussed before, the subject system can stores data as tables in the columnar format, with the support of user-defined access paths (i.e., the secondary indexes). A table API allows applications to directly address both user tables and secondary indexes.

As shown in the code listing 1110, an application uses a secondary index to locate data of interest, and then performs a key/foreign-key join to retrieve the images from the primary dataset table for image thresholding processing.

The follow discussion relates to the subject system's storage layer design which provides 1) a hybrid data store that supports both high velocity updates at the data curation stage and high throughput reads at the training stage, 2) a scalable physical data layout that can support ever-growing data volume, and efficiently record and track deltas between different versions of the same object, and 3) partitioned indices that support dynamic range queries, point queries, and efficient streaming on-demand for distributed training. This discussion refers back to components of FIG. 2 as previously discussed, especially with respect to components of the server 130 and its storage-related components.

At early stages of data collection and data curation, raw data assets and features are stored in an in-flight data store (e.g., as shown in FIG. 2 as in-flight data store 280) in an implementation. The in-flight data store uses a distributed key-value store that supports efficient in-situ updates and appends concurrently at a high velocity. In an example, the in-flight data store only keeps the current version of its data. Snapshots can be taken and published to the subject system's curated data store (e.g., the curated data stores 282 of FIG. 2), which is a versioned data store based on a distributed cloud storage system. The curated data store is read-optimized, and supports efficient append-only updates and sub-optimal in-situ updates based on copy-on-write. Changes to a snapshot in the curated store can result in a new version of the snapshot. A published snapshot can be kept in the system to ensure reproducibility of ML experiments until the snapshot is archived or purged.

Data movement between the in-flight and curated data stores is managed by a subsystem, referred to herein as a “data-pipe” or “data pipe” (e.g., the data pipes 281). Each logical data block in both data stores maintains a unique identifier, a logical checksum, and a timestamp of last modification. A data-pipe uses this information to track deltas (e.g., changes) between different versions of the same dataset.

In an example, matured datasets can be removed from the in-flight store after storing the latest snapshot in the curated store. On the other hand, if needed, a copy of a snapshot can be moved back to the in-flight store for further modification at a high velocity and volume. After the modification is complete, it can be published to the curated data store as a new version. Despite the multiple data stores, the subject system offers a unified data access interface. The visibility of the two different data stores is for administrative reasons to ease the management of data life cycle by the data owners. In an example, it is also worth noting that using data from the in-flight store for ML experiments is discouraged, since the experiment results may not be reproducible due to the fact that data in the in-flight store may be overwritten.

The subject technology provides a scalable data layout. In an implementation, the subject system stores its data in partitions, managed by the system. The partitioning scheme cannot be directly specified by the users. However, users may define a sort key on the data in the subject system. The sort key can he used as the prefix of the range partition key. In an example, since there is no uniqueness requirement on the user-defined sort key, in order to provide a stable sorting order based on data injection time, the system appends a timestamp to the partition key. If no sort key is defined, the system automatically uses the hash of the primary key as the range partition key. The choices of the sort keys depend on the sequential access patterns to the data, similar to the problem of physical database design in relational databases.

In case of data skew in the user-defined sort key, the appended timestamp column helps alleviate the partition skew problem. The timestamp provides sufficient entropy to split a partition either based on heat or based on volume. in addition, range partitioning will allow the data volume to scale out efficiently without the issue of global data shuffling that naive hash partition schemes suffer from.

Each logical partition is further divided into a sequence of physical data blocks. The size of the data blocks is variable and can be adjusted based on access patterns. Both splits and merges of data blocks are localized to the neighboring blocks, with minimum data copying and movement. This design choice is particularly influenced by the fact that published versions of the subject system data are immutable. Version evolutions typically touch a fraction of the original data. With the characteristics of minimum and localized changes, old and new versions can share common data blocks whose data remain unchanged between versions.

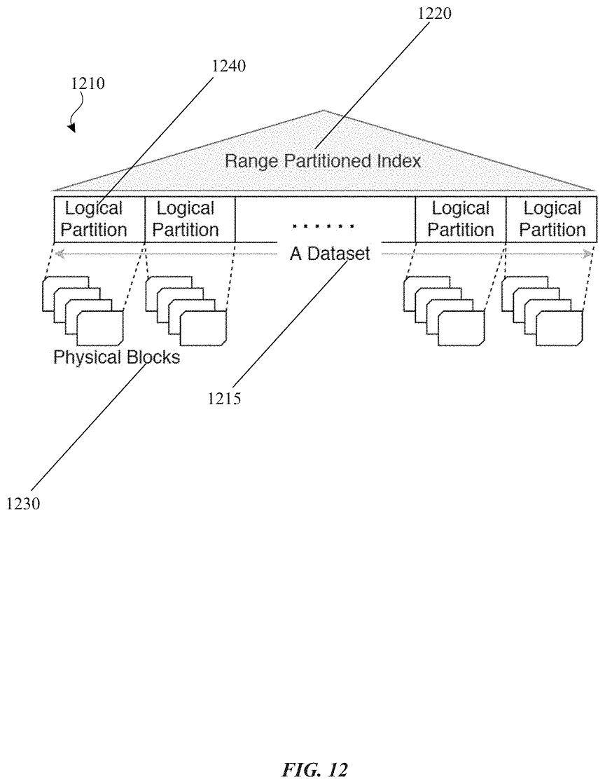

FIG. 12 illustrates a representation of a physical data layout 1210 in accordance with one or more implementations of the subject technology. As previously discussed in FIG. 2, curated data and in-flight data may be stored in respective storage areas (e.g., the curated data stores 282 and the in-flight data store 280).

FIG. 12 illustrates an example range partition index 1220 and logical partitions 1240 for a dataset 1215. As shown, a respective set of physical blocks 1230 are included in each of the logical partitions 1240 where the physical blocks 1230 are written to storage (e.g., the curated data stores 282 or the in-flight data store 280).

As shown in FIG. 12, the physical data layout 1210 is based on range partitioning in an example. In an implementation, the subject system's storage engine maintains an additional index on a range partition key to efficiently locate a particular partition/data. block based on user predicates.

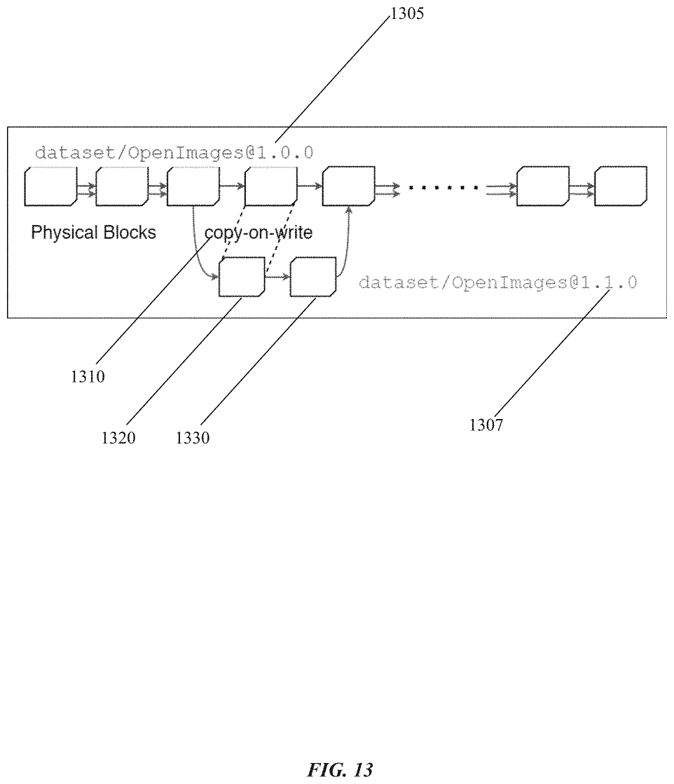

When a new version is created with incremental changes to the original previous) version, only the affected data blocks are created with a copy-on-write operation which is described in further detail in FIG. 13 below.

FIG. 13 illustrates a representation of creating a new version of a dataset using a copy-on-write operation 1310 in accordance with one or more implementations of the subject technology.

Since a given data set may be very large in terms of size (e.g., hundreds of gigabytes, tens of terabytes, etc.), optimizing write operations as shown in FIG. 13 advantageously improves the performance of the subject system by avoiding writing an entire data set to storage when a new version of the data set is provided. For example, for a given file that is included in a first data set and a new version of the first data set, the subject system may include a pointer to the same file for both data sets (e.g., the first version and the new version). When the new version of the same file is updated, the subject system can then initiate a copy-on-write operation to store the updated file or the updated portions (e.g., updated physical blocks) thereof as discussed further below. In an example, only a set of physical blocks that have changed are copied as part of the copy-on-write operation.

FIG. 13 includes an original data set 1305 with version 1.0.0. As shown in FIG. 13, updates trigger a copy of the original data block as part of a copy-on-write operation 1310, followed by a split, and a new version of the data set 1307 is created with minimum data movement. In the example of FIG. 13, physical block 1320 and physical block 1330 correspond to updated physical blocks in the new version of the data set 1307 which are written to storage as part of the copy-on-write operation 1310.

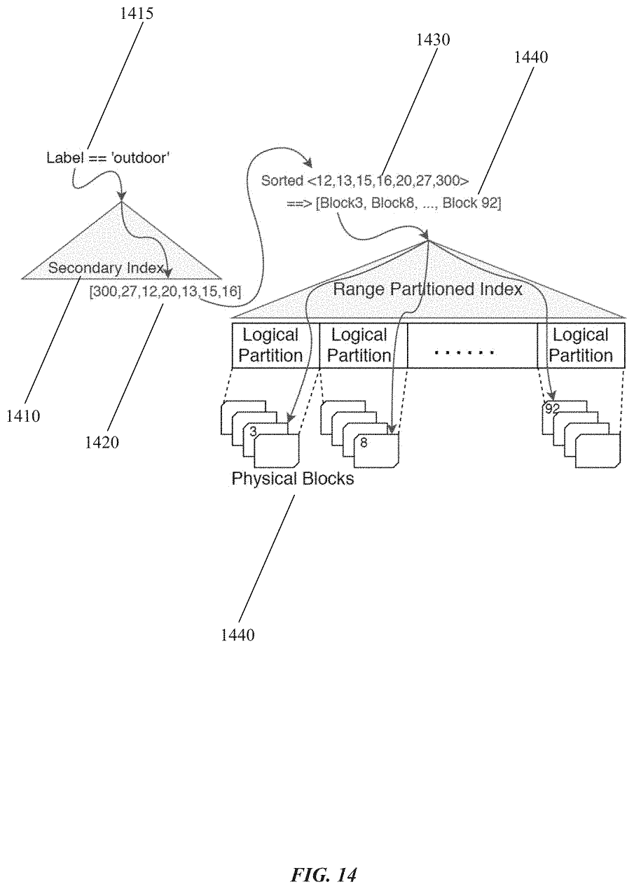

FIG. 14 illustrates an example of using a secondary index 1410 to map keys into data block identifiers (IDs) and to retrieve data of interest in accordance with one or more implementations of the subject technology.

FIG. 14 illustrates an example of using a secondary index 1410 to map keys into data block identifiers (IDs) and to retrieve data of interest in accordance with one or more implementations of the subject technology. In particular, FIG. 14 illustrates the use of the secondary index 1410 to batch block POs as discussed below.

As shown in FIG. 14, a search for data with a label 1415 corresponding to an “outdoor” tag is performed in the subject system for a given data set. To support such a search, the subject system provides the secondary index 1410 which will call out a set of primary index values 1420 (e.g., keys) and sort the set of primary index values 1420 to provide a sorted set of primary index values 1430.

In an implementation, a primary index value is required for each data set. Such a primary index value refers to an identifier that is unique for the data set that is represented as a table. In an example, there is a column in the table corresponding to a primary index for the table where the primary index enables each value in that column to uniquely identify a corresponding row. Thus, the primary key in an implementation can be represented as a number with a requirement that there cannot be any duplicate values in the system. In an implementation, after the primary keys determined, the primary keys may be sorted to identify, in a sequential manner or particular order, a set of physical blocks 1440 that correspond to the data that matches the search since the physical blocks are stored in the same sorted primary key order. Thus, it is appreciated that corresponding data that matches the search can be determined in the data set without requiring an iteration of each physical block of a given data set, which improves the speed of completing such a search and potentially reduces consumption of processing resources in the subject system in view of the large size of data sets for machine learning applications. Further, the implementation of the secondary index as shown in the example of FIG. 14 enables support for other features of the subject system including at least streaming of data (e.g., on demand) from a given data set as discussed herein, and/or other operations with the data set including range scan, point query, etc., as discussed further below.

The following discussion relates to the subject system's data layout design shown in FIG. 14 that enables the following optimization strategies that provide benefits to ML access patterns.

With respect to data parallelism, typical data and feature engineering tasks are highly parailelizable. The subject system can exploit the interesting partition properties as well as the existing partition boundaries to optimize the task execution. In addition, for distributed training where data is divided into subsets for individual workers, the partitioned input provides a good starting point before the data needs to be randomized and shuffled.

In regard to streaming on-demand, ML training experiments may target only a subset of the entire dataset, e.g., to train a model to classify the dog breeds, and a ML model may only be interested in the dog images from the entire computer vision dataset. After identifying the image IDs, the actual images might be scattered across many partitions, the data block layout design will allow a client to stream only those data blocks of interest. In addition, many training tasks have a predetermined access sequence, a fine-tuned data block size gives the system a fine-grained control on prefetching optimization. Moreover, streaming I/O improves the resource utilization, especially with respect to highly contended CPUs, by reducing the idle-time waiting for the entire training data. Before the streaming I/O feature was provided, each training task had a long initial idle-time, and busy-waiting for the entire data to be downloaded.

For range scan and point query operations, each data block and partition contains aggregated information about the key ranges within. The data blocks are linearly linked to support efficient scans, while the index over the key ranges allows efficient point queries.

With respect to secondary indexes, the subject system allows users to materialize search results, similar to materialized views in databases. Secondary indexes are simpler variations of generic materialized views. The leaf-nodes of the secondary indexes store a collection of partition keys. Since the subject system employs range partitioning, the system can easily sort and map the keys into partition Ms and data block IDs without duplication. This further improves the I/O throughput and latency by batching multiple key requests into a single block I/O.

The following discussion relates to a distributed cache, which is provided in one or more implementations of the subject technology. In an example, such a distributed cache provided by the subject technology can viewed as a modular cache which enables deployment to multiple execution environments to maintain a level of predictability to performance for a given machine learning application as such a machine learning application tends to be more read-intensive than write-intensive. In an example, ML applications perform client-side data processing, i.e., bringing data to compute. In order to shorten the data distance, the subject system provides a transparent distributed cache in the data center collocated with the compute cluster of ML tasks. The cache service is transparent to applications, since applications do not directly address the cache service endpoint, instead such applications connect to an API endpoint. If the subject system finds a cache service that is collocated with the execution cluster where the application is running, it will notify the client to redirect all subsequent data API calls to the cache cluster. The subject system client has a built-in fail-safe in case the cache service becomes unavailable, the data API calls fall back to the subject system service endpoint.

In an example, many different execution environments are used by different teams, and more are being added as ML projects/teams proliferate in various domains. The cache service can be deployable to any virtual cluster environment that enables setting up the cache service as soon as the execution environment is ready.

The cache service is enabled to achieve read scale-out, in addition to the reduction of data latency. The system throughput increases by scaling out existing cache services, or by setting up new cache deployments. In an example, the cache service only caches read-only snapshots of the data, i.e., the published versions of data. The decision favors a simple design to guarantee strong consistency of the data. The anomalies caused by the eventual consistency model impede the reproducibility guarantee. If mutable data were also cached, in order to ensure transactional consistency of the cached data, data under higher volume of updates not only will not benefit from caching, but the frequent cache invalidation puts counterproductive overheads to the cache service.

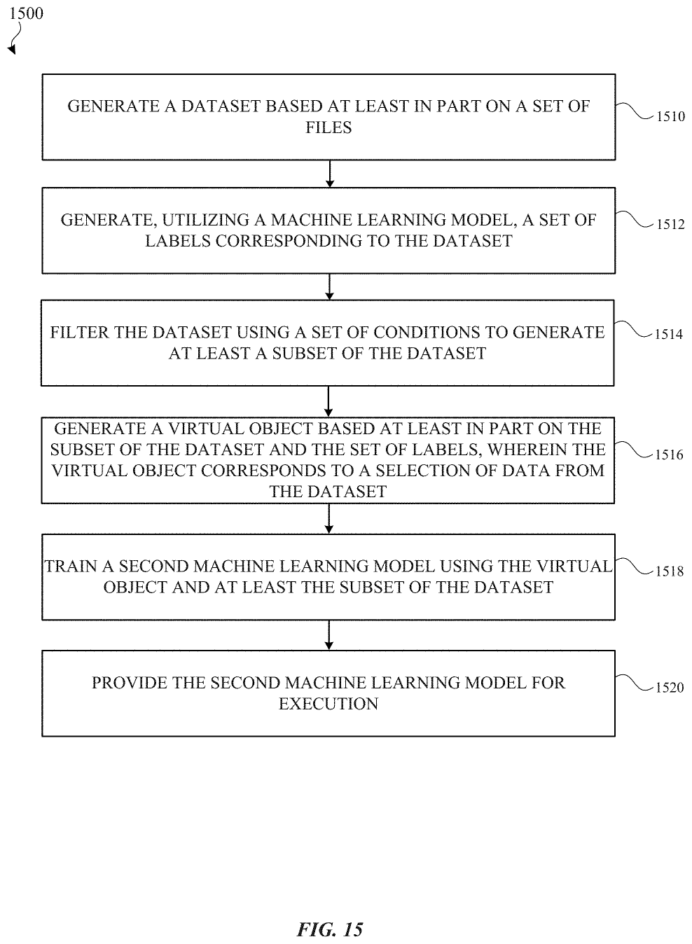

FIG. 15 illustrates a flow diagram of an example process 1500 for creating a dataset and other objects for training a machine learning model in accordance with one or more implementations. For explanatory purposes, the process 1500 is primarily described herein with reference to components of the computing architecture of FIG. 2, which may be executed by one or more processors of the electronic device 110 of FIG. 1. However, the process 1500 is not limited to the electronic device 110, and one or more blocks (or operations) of the process 1500 may be performed by one or more other components of other suitable devices, such as by the electronic device 110. Further for explanatory purposes, the blocks of the process 1500 are described herein as occurring in serial, or linearly. However, multiple blocks of the process 1500 may occur in parallel, In addition, the blocks of the process 1500 need not be performed in the order shown and/or one or more blocks of the process 1500 need not be performed and/or can be replaced by other operations.

The electronic device 110 generates a dataset based at least in part on a set of files (1510). In an example, the set of files include raw data that is used at least as inputs for training a particular machine learning model and/or evaluation of such a machine learning model. The electronic device 110 generates, utilizing a machine learning model, a set of labels corresponding to the dataset (1512). In an example, the machine learning model is pre-trained based at least in part on a portion of the dataset, and a different machine learning model generates a different set of labels based on the dataset thereby forgoing duplicating the dataset that results in increasing storage usage. The electronic device 110 filters the dataset using a set of conditions to generate at least a subset of the dataset (1514). In an example, the set of conditions includes various values that are utilized to match data found in the dataset and generate the subset of the dataset similar to using a “WHERE” statement in an SQL database command.

The electronic device generates a virtual object based at least in part on the subset of the dataset and the set of labels, wherein the virtual object corresponds to a selection of data (e.g., defining columns of the view) similar to a particular query of the dataset (1516). In an example, the virtual object (e.g., the package) is based at least in part on a particular query with SQL-like commands such as defining a selection of columns in the dataset and/or joining data from annotations and/or splits objects, which was discussed in more detail in FIG. 8 above. The electronic device 110 trains a second machine learning model using the virtual object and at least the subset of the dataset (1518). Further, the electronic device 110 provides the second machine learning model for execution either locally at the electronic device 110 or at a remote server (e.g., the server 120 or the server 150) (1520).

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated. non-personal information data or a bare minimum amount of personal information, such as the content being handled only on the user's device or other non-personal information available to the content delivery services,

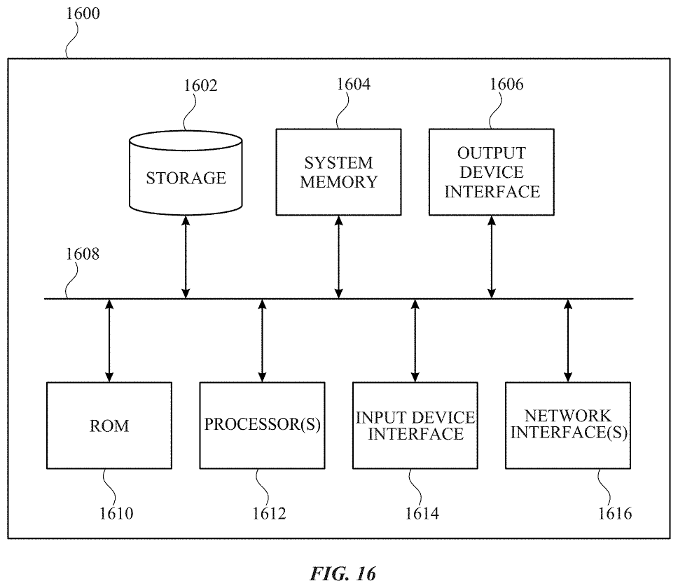

FIG. 16 illustrates an electronic system 1600 with which one or more implementations of the subject technology may be implemented. The electronic system 1600 can be, and/or can be a part of, the electronic device 110, and/or the server 120, and/or the server 130 shown in FIG. 1. The electronic system 1600 may include various types of computer readable media and interfaces for various other types of computer readable media. The electronic system 1600 includes a bus 1608, one or more processing unit(s) 1612, a system memory 1604 (and/or buffer), a ROM 1610, a permanent storage device 1602, an input device interface 1614, an output device interface 1606, and one or more network interfaces 1616, or subsets and variations thereof.

The bus 1608 collectively represents all system, peripheral, and chipset buses that communicatively connect the numerous internal devices of the electronic system 1600. In one or more implementations, the bus 1608 communicatively connects the one or more processing unit(s) 1612 with the ROM 1610, the system memory 1604, and the permanent storage device 1602. From these various memory units, the one or more processing unit(s) 1612 retrieves instructions to execute and data to process in order to execute the processes of the subject disclosure. The one or more processing unit(s) 1612 can be a single processor or a multi-core processor in different implementations.

The ROM 1610 stores static data and instructions that are needed by the one or more processing unit(s) 1612 and other modules of the electronic system 1600. The permanent storage device 1602, on the other hand, may be a read-and-write memory device. The permanent storage device 1602 may be a non-volatile memory unit that stores instructions and data even when the electronic system 1600 is off. In one or more implementations, a mass-storage device (such as a magnetic or optical disk and its corresponding disk drive) may be used as the permanent storage device 1602.

In one or more implementations, a removable storage device (such as a floppy disk, flash drive, and its corresponding disk drive) may be used as the permanent storage device 1602. Like the permanent storage device 1602, the system memory 1604 may be a read-and-write memory device. However, unlike the permanent storage device 1602, the system memory 1604 may be a volatile read-and-write memory, such as random access memory. The system memory 1604 may store any of the instructions and data that one or more processing unit(s) 1612 may need at runtime. In one or more implementations, the processes of the subject disclosure are stored in the system memory 1604, the permanent storage device 1602, and/or the ROM 1610. From these various memory units, the one or more processing unit(s) 1612 retrieves instructions to execute and data to process in order to execute the processes of one or more implementations.

The bus 1608 also connects to the input and output device interfaces 1614 and 1606. The input device interface 1614 enables a user to communicate information and select commands to the electronic system 1600. Input devices that may be used with the input device interface 1614 may include, for example, alphanumeric keyboards and pointing devices (also called “cursor control devices”). The output device interface 1606 may enable, for example, the display of images generated by electronic system 1600. Output devices that may be used with the output device interface 1606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 16, the bus 1608 also couples the electronic system 1600 to one or more networks and/or to one or more network nodes, such as the electronic device 160 shown in FIG. 1, through the one or more network interface(s) 1616. In this manner, the electronic system 1600 can be a part of a network of computers (such as a LAN, a wide area network (“WAN”), or an Intranet, or a network of networks, such as the Internet. Any or all components of the electronic system 1600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to he accorded the full scope consistent with the language claims, wherein reference to an element in the singular is not intended to mean “one and only one” unless specifically so stated, but rather “one or more”, Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
generating a dataset based at least in part on a set of files;
generating, utilizing a machine learning model, a set of labels corresponding to the dataset, wherein the machine learning model is pre-trained based at least in part on a portion of the dataset;
filtering the dataset using a set of conditions to generate at least a subset of the dataset;
generating a virtual object based at least in part on the subset of the dataset and the set of labels, wherein the virtual object corresponds to a selection of data from the dataset; and
training a second machine learning model using the virtual object and at least the subset of the dataset, wherein training the second machine learning model includes utilizing streaming file input/output (I/O), the streaming file I/O providing access to at least the subset of the dataset during training.

2. The method of claim 1, wherein training the second machine learning model further comprises:
performing a mount command to provide access to raw files from the subset of the dataset, the mount command enabling streaming access to different raw files in one or more machine learning frameworks or stored in one or more respective storage locations.

3. The method of claim 1, wherein the set of files represents an abstraction of raw data that is stored remotely in cloud storage, and the machine learning model is pre-trained, and the method further comprising:
providing e second machine learning model for execution at a local electronic device or at a remote server.

4. The method of claim 1, wherein the set of labels comprises metadata corresponding to extracted features or supplementary properties of the dataset.

5. The method of claim 1, further comprising:
creating a split object based at least in part on the filtering the dataset using the set of conditions, the split object comprising the subset of the dataset and a second subset of the dataset.

6. The method of claim 5, wherein the subset of the dataset comprises training data and the second subset of the dataset comprises validation data, the training data and the validation data comprising respective mutually exclusive subsets of the dataset.

7. The method of claim 1, wherein the set of files include raw data that is used as inputs for evaluation of the machine learning model, and further comprising:
generating, utilizing a different machine learning model, a second set of labels corresponding to the dataset, wherein the second set of labels is different than the set of labels generated by the machine learning model;
filtering the dataset using a second set of conditions to generate at least a second subset of the dataset;
generating a second virtual object based at least in part on the second subset of the dataset and the second set of labels; and
training a third machine learning model using the second virtual object and at least the second subset of the dataset.

8. The method of claim wherein training the second machine learning model using the virtual object and at least the subset of the dataset further comprises:
training the second machine learning model based at least in part on a first dataset corresponding to a query on the dataset provided by the virtual object; and
validating the second machine learning model based at least in part on a second dataset corresponding to a second query on the dataset provided by the virtual object.

9. The method of claim 8, wherein the query and the second query on the dataset are submitted to a cloud service for execution.

10. The method of claim 1, wherein the second machine learning model provides a prediction using a second dataset as input.

11. A system comprising:
a processor;
a memory device containing instructions, which when executed by the processor cause the processor to:
generate a dataset based at least in part on a set of files;
generate, utilizing a machine learning model, a set of labels corresponding to the dataset, wherein the machine learning model is pre-trained based at least in part on a portion of the dataset;
filter the dataset using a set of conditions to generate at least a subset of the dataset;
generate a virtual object based at least n part on the subset of the dataset and the set of labels; and
train a second machine learning model using the virtual object and at least the subset of the dataset, wherein to train the second machine learning model includes providing a file system view of raw files from the subset of the dataset.

12. The system of claim 11, wherein to train the second machine learning model further causes the processor to:
perform a mount command to provide access to raw files from the subset of the dataset in a logical file system, wherein the mount command provides the file system view of the raw files, the file system view enabling access to different raw files in one or more machine learning frameworks or stored in one or more respective storage locations.

13. The system of claim 11, wherein the set of files represents an abstraction of raw data that is stored remotely in cloud storage, the machine learning model is pre-trained, and the memory device contains further instructions, which when executed by the processor further cause the processor to:
provide the second machine learning model for execution at a local electronic device or at a remote server.

14. The system of claim 11, wherein the set of labels comprises metadata corresponding to extracted features or supplementary properties of the dataset.

15. The system of claim 11, wherein the memory device contains further instructions, which when executed by the processor further cause the processor to:
create a split object based at least in part on the filtering the dataset using the set of conditions, the split object comprising the subset of the dataset and a second subset of the dataset.

16. The system of claim 15, wherein the subset of the dataset comprises training data and the second subset of the dataset comprises validation data, the training data and the validation data comprising respective mutually exclusive subsets of the dataset.

17. The system of claim 11, wherein the set of files includes raw data that is used as inputs for evaluation of the machine learning model.

18. The system of claim 11, wherein to train the second machine learning model using the virtual object and at least the subset of the dataset further causes the processor to:
train the second machine learning model based at least in part on a first dataset corresponding to a query on the dataset provided by the virtual object; and
validate the second machine learning model based at least in part on a second dataset corresponding to a second query on the dataset provided by the virtual object.

19. The system of claim 18, wherein the query and the second query on the dataset are submitted to a cloud service for execution.

20. A non-transitory computer-readable medium comprising instructions, which when executed by a computing device, cause the computing device to perform operations comprising:
generating a dataset object based at least in part on a set of files;
generating, utilizing a machine learning model, an annotation object corresponding to the dataset object, the annotation object corresponding to a set of labels for the dataset object, wherein the machine learning model is pre-trained based at least in part on a portion of the dataset object;
filtering the dataset using a set of conditions to generate a split object, the split object corresponding to at least a subset of the dataset;
generating a virtual object based at least in part on the subset of the dataset object and the annotation object; and
training a second machine learning model using the virtual object and at least the split object.
